(19) United States
(12) Patent Application Publication
(10) Pub. No.: US 2005/0197935 A1
(43) Pub. Date: Sep. 8, 2005

(54) Wireless networking cash register

(75) Inventor: Scott Tseng, Taipei Hsien (TW)

Correspondence Address: DENNISON, SCHULTZ & DOUGHERTY, 612 CRYSTAL SQUARE 4, 1745 JEFFERSON DAVIS HIGHWAY, ARLINGTON, VA, 22202, US

(73) Assignee: TAICOM DATA SYSTEMS CO., LTD.

(21) Appl. No.: 10/747,052

(22) Filed: Dec. 30, 2003

(51) Int. Cl. G06F 17/60

(52) U.S. Cl. 705/35

(57) ABSTRACT

A wireless networking cash register comprises a cash register, a wireless networking HUB, a code generator and a charge counter; the cash register has therein an electric circuit board electrically connecting with the code generator and the charge counter, and has externally thereof a display, a printer and an inputting keyboard. The wireless networking HUB is built in the cash register, and has a set of antenna, at least a wide area network (WAN) interface and a local area network (LAN) interface. Thereby, the code generator in the cash register generates a code for networking of the user, and the charge counter starts to calculate the charge for networking. The display displays the trading information, and the printer prints the detail statement of trading. The cash register is applicable to the business activity fields such as general cafés, network cafés, breakfast shops, restaurants and hotels etc.

### BACKGROUND OF THE INVENTION

1. Field of the Invention

The present invention is related to a wireless networking cash register, and especially to a structure that can connect a wide area network (WAN) and a local area network (LAN), and can transmit wirelessly and calculate the networking time of a computer in the local area network (LAN) as well as the consuming sum of money charged. The structure is further connected with a display and a printer. The present invention is applicable to the business activity fields such as general cafés, network cafés, breakfast shops, restaurants and hotels etc.

2. Description of the Prior Art

In the recent years, by the rapid development of computer networks, trading of commodities, searching of information, and even chatting, entertaining on a network etc. can all be fulfilled by networking. People more and more rely on computer networks. Therefore computer networks make people's lives more convenient, and create more commercial chances. In view of this, network providers all vigorously try hard to study and develop, and cable networks that must be provided with complex transmitting lines are changed during progressing to wireless networks.

Utilization of wireless networks is quite broad. Taking the network café as an example, as shown in FIG. 7, when users use computers “a” with wireless network cards for networking, they can use bridges or Access Points (AP) “b” to connect their computers “a” with Internet. The networking time and the consuming sum of money charged from the users starting networking to shutting their computers “a” must be calculated by ISP (internet service provider) and then given to the administrator who can then print detail statements for the users according to the information provided by ISP that is shown in the display for settlement.

In management of stores for network services, the consuming times and consuming sum of money charged for networking of the users are completely calculated by the provider of ISP and are sent back to the administrator as stated above. This must increase the systematic extraordinary disbursement and shall be subjected to the risk of raising the service charges by ISP, This is uneconomic for general middle and small stores. Moreover, an administrator must simultaneously own a monitoring computer, a display and a cash register. This wastes space and increases the purchasing cost in business management.

In view of the above statement and in order to overcome the above stated defects, the inventor of the present invention provides a wireless networking cash register based on his professional experience of years and after hard study as well as developing, the wireless networking cash register not only can connect with a wide area network (WAN) and a local area network (LAN), but also can automatically calculate the consuming times and consuming sum of money charged for networking of the users in its local area network and can connect with a display and a printer.

### SUMMARY OF THE INVENTION

The primary object of the present invention is to provide a wireless networking cash register which can allow a user to connect any equipment having the wireless-broadband transmitting function with the present invention wirelessly, and simultaneously with a cash register, a display and a printer. The functions of all the devices can thus be integrated, and the procedure of operation can thus be simplified.

The secondary object of the present invention is to provide a wireless networking cash register which can be connected with a wide area network (WAN) and a local area network (LAN); a code generator generates a code before the user uses the computer in a local area network for networking of the user, and starts to calculate the networking time. When the user finishes the networking, the consuming time and consuming sum of money charged for networking on the computer can be calculated according to the input of the inputting keyboard on the panel of the cash register. The wireless networking cash register can be mounted easily, and then there is no need for the provider of ISP to do the calculation work.

To achieve the above objects of the present invention, the wireless networking cash register of the present invention comprises a cash register, a wireless networking HUB, a code generator and a charge counter. The cash register is provided therein with an electric circuit board electrically connecting with the code generator and the charge counter. The cash register is further provided externally thereof with a display, a printer and an inputting keyboard. The wireless networking HUB is built in the cash register, and has a set of antenna, at least a wide area network (WAN) interface and a local area network (LAN) interface. Thereby, the code generator in the cash register generates a code for networking of the user, and the charge counter starts to calculate the charge for networking. The display displays the trading information, and the printer prints the detail statement of trading. The present invention will be apparent after reading the detailed description of the preferred embodiment thereof in reference to the accompanying drawings.

### BRIEF DESCRIPTION OF THE DRAWINGS

FIG. 1 is a perspective view showing the appearance of the wireless networking cash register of the present invention;

FIG. 2 is a schematic view showing the circuit connection of main elements of the present invention;

FIG. 3 is a block diagram of the main elements of the present invention;

FIG. 4 is a schematic perspective view showing the first example of application of the present invention;

FIG. 5 is a flow chart showing the process of using of the present invention;

FIG. 6 is a schematic perspective view showing the second example of application of the present invention;

FIG. 7 is a perspective schematic view showing allocation of wireless networking of a conventional network café.

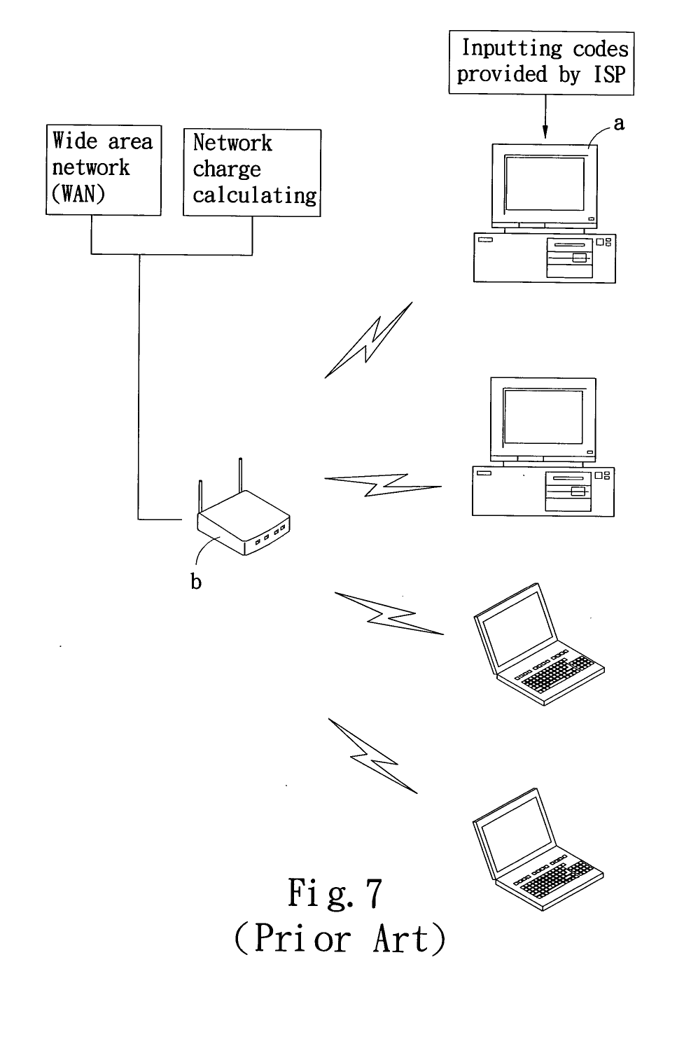

### DETAILED DESCRIPTION OF THE PREFERRED EMBODIMENT

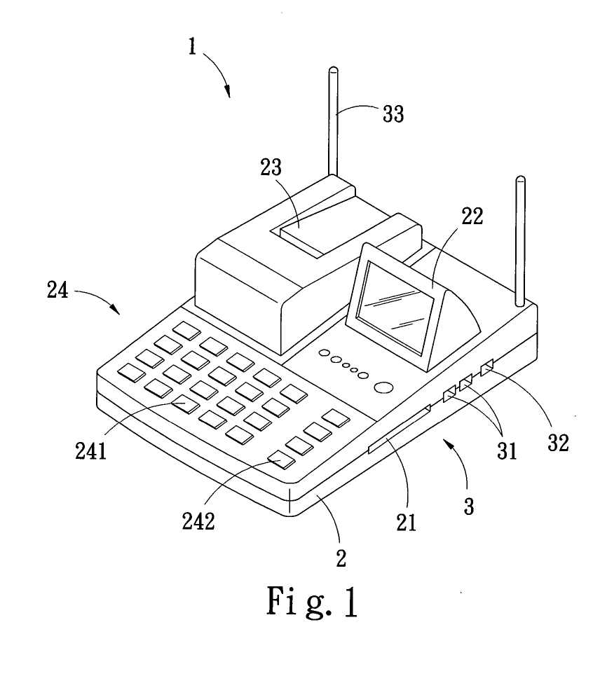

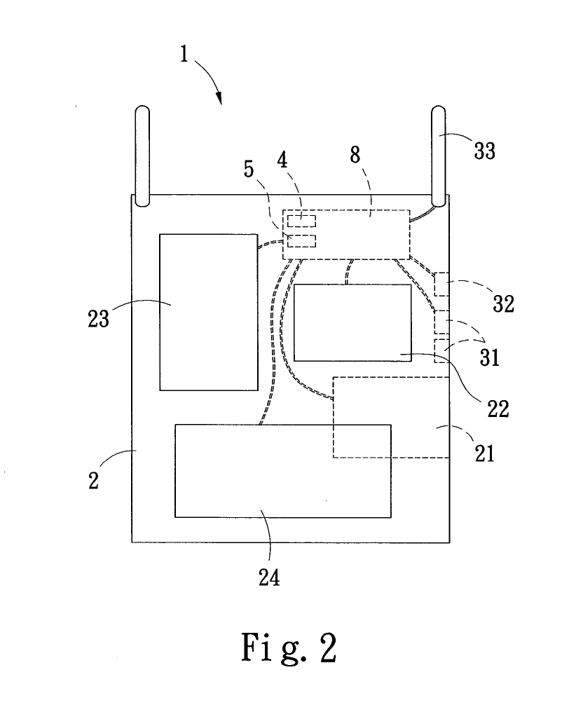

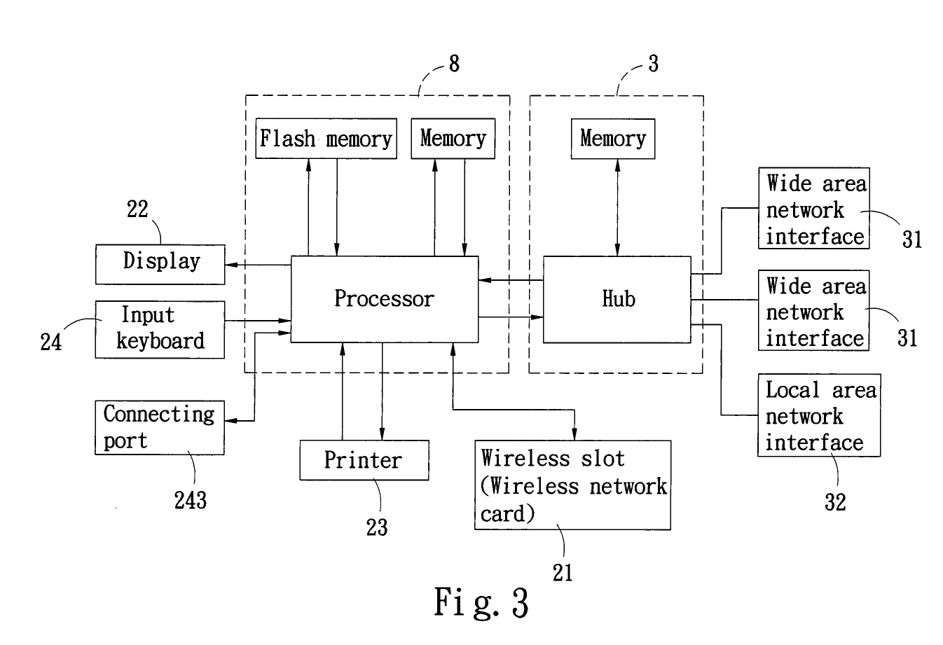

Referring to FIGS. 1-3, the wireless networking cash register 1 of the present invention comprises a cash register 2, a wireless networking HUB 3, a code generator 4 and a charge counter 5.

The cash register 2 has on one side thereof a wireless slot 21 for insertion of a wireless network card. The cash register 2 is provided therein with an electric circuit board 8, and is further provided externally thereof with a display 22, a printer 23 and an inputting keyboard 24 which includes a plurality of data inputting keys 241 and at least a functional key 242. The cash register 2 can be flexibly provided with at least an augment connecting port 243 to connect peripheral equipment of a computer.

The wireless networking HUB 3 is built in the cash register, and has a set of antenna, at least a wide area network (WAN) interface 31 (there are two in this embodiment), a local area network (LAN) interface 32 and a set of antenna 33. The antenna 33 is fixed on the cash register 2 in this embodiment, but it can be separated from the cash register 2 when in using, and can be adjusted by position in different sites.

The code generator 4 and the charge counter 5 are provided in the cash register 2, and are electrically connected with the electric circuit board 8. The code generator 4 and the charge counter 5 can be independently mounted hardware, and also can be firmware attached to the electric circuit board 8.

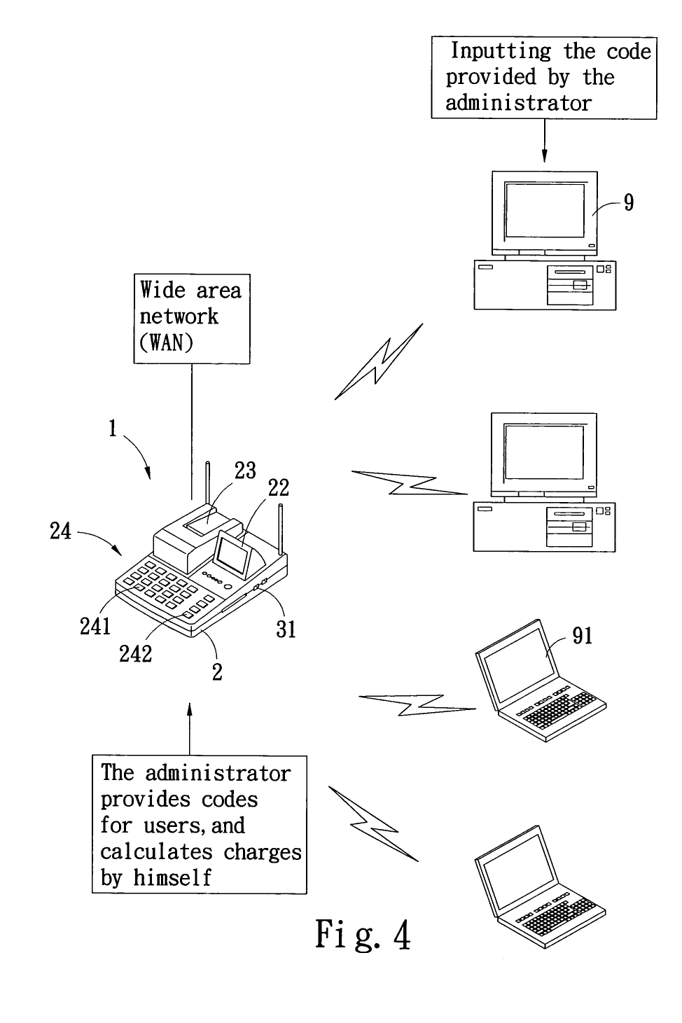

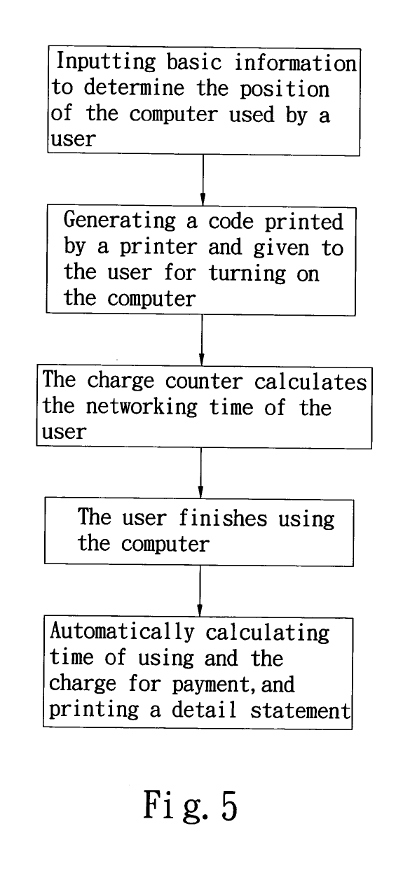

Referring to FIGS. 4 and 5 showing the first example of application of the present invention, an administrator of a store can input the seat number and the computer number to be used through the data inputting keys 241 on the cash register 2 in advance when a user gets into the store. The code generator 4 generates automatically a code of a random number used in the store, the code is printed by the printer 23 and given to the user, the user then applies the code on the computer 9 provided by the administrator or any equipment provided by himself having the wireless broadband transmitting function (for example a notebook 91 or a game machine). The user can get in a network at once when he turns on the computer 9 and inputs the code, and the charge counter 5 starts to calculate the networking time. After the user finishes networking, the charge counter 5 automatically calculates the sum of money of networking charged on the computer 9. The display 22 displays the trading information when in settlement, and the printer 23 prints the detail statement of trading for the user. The mode that the user shall pay the charge (e.g. pay monthly, reckon the sum of hours etc.) can be controlled by inputting various settings with the functional keys 242 on the inputting keyboard 24; therefore, the basic charge amount set can be adjusted automatically in pursuance of various services provided by different businesses. Application of the present invention is quite flexible.

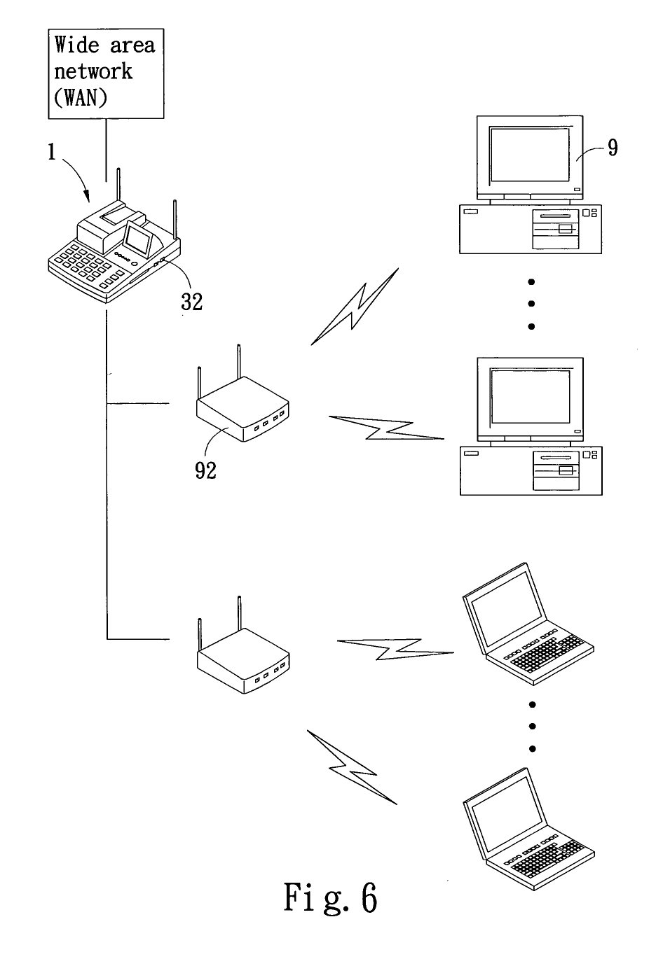

Referring to FIG. 6 showing the second example of application of the present invention, when the present invention must control multiple computers 9, the local area network interface 32 for the present invention can be connected to the local area network, the computers 9 are wirelessly connected by using Access Points (AP) 92 to monitor their states of networking.

Thereby, the present invention has the following advantages:
1. The present invention integrates the functions of a cash register, a display and a printer on a single device. The device can simultaneously be connected with a wide area network (WAN) and a local area network (LAN), and can monitor different amounts of computers according to allocation of the computers. Thereby not only the cost of purchasing various devices can be saved, and the space occupied can be reduced. These can effectively simplify the connection as well as operation procedure between these devices and the network.
2. The present invention can allow a user to wirelessly connect any equipment having the wireless-broadband transmitting function with the present invention. With a cash register, code generating before turning on the computers for networking and calculation of networking time and consuming sum of money charged after finishing networking can be completed just by operating the keys on the panel of the cash register without further calculating by the provider of ISP. This can save the systematic extraordinary disbursement.
3. The present invention has a function of wirelessly transmitting, the wirelessly networking function of it can be changed and adjusted flexibly according to different sizes of business fields; thereby it is quite convenient in allocation as well as use and operation.

In conclusion, according to the above-disclosed content, the present invention can surely get the expected objects thereof to provide a wireless networking cash register. The cash register can simultaneously be connected with a wide area network (WAN) and a local area network (LAN), and can calculate the networking time of computers in the local area network (LAN) and consuming sum of money charged. The cash register can be further connected with a display and a printer. Having thus described my invention that is extremely practical, what I claim as new and desire to be secured by Letters Patent of the United States are:

1. A wireless networking cash register comprising:
a cash register, being provided therein with an electric circuit board, and being provided externally thereof with a display, a printer and an inputting keyboard;
a wireless networking HUB, being built in said cash register, and having a set of antenna, at least a wide area network (WAN) interface and a local area network (LAN) interface;
a code generator, being provided in said cash register, and electrically connecting with said electric circuit board; and
a charge counter, being provided in said cash register, and electrically connecting with said electric circuit board;
with said cash register, said code generator in said cash register generates a code for networking of a user, and said charge counter starts to calculate charge for networking, said display displays trading information, and said printer prints detail statement of trading.

2. The wireless networking cash register as stated in claim 1, wherein said code generator and said charge counter are independently mounted hardware.

3. The wireless networking cash register as stated in claim 1, wherein said code generator and said charge counter are firmware attached to said electric circuit board.

4. The wireless networking cash register as stated in claim 1, wherein said inputting keyboard includes a plurality of data inputting keys and at least a functional key.

5. The wireless networking cash register as stated in claim 1, wherein said cash register has a wireless slot for insertion of a wireless network card.

6. The wireless networking cash register as stated in claim 1, wherein said cash register is provided with at least a connecting port to connect peripheral equipment of a computer.

7. The wireless networking cash register as stated in claim 1, wherein said wide area network (WAN) interfaces are two in number.
